(19) United States
(12) Patent Application Publication
(10) Pub. No.: US 2026/0281922 A1
(43) Pub. Date: Sep. 17, 2026

(54) RECOGNITION-MODULATED WIRELESS COMMUNICATION SYSTEM AND METHODS FOR CONTROLLING WIRELESS TRANSMISSION PARAMETERS

(71) Applicant: Jonathan Washburn, Austin, TX (US)

(72) Inventor: Jonathan Washburn, Austin, TX (US)

(21) Appl. No.: 19/560,887

(22) Filed: Mar. 9, 2026

Related U.S. Application Data
(60) Provisional application No. 63/770,746, filed on Mar. 12, 2025.

(51) Int. Cl. H04W 52/48; H04L 1/1812; H04L 1/20; H04W 52/20

(52) U.S. Cl. CPC H04W 52/48; H04L 1/1812; H04L 1/203; H04W 52/20

(57) ABSTRACT

A wireless communication system, method, and non-transitory computer-readable medium are disclosed for controlling wireless operating parameters using a bounded monotone recognition mapping. At least one non-negative recognition metric associated with a wireless condition is obtained, and a recognition coefficient is computed according to F_cov(r)=r/(r+X), where X is a positive constant. A complementary coefficient may also be used according to X/(r+X). The computed coefficient is applied to control one or more wireless operating parameters associated with transmission, reception, channel estimation, equalization, synchronization, coding, retransmission, power control, beamforming, precoding, combining, scheduling, handover, multi-link selection, routing, interference management, or cross-layer resource allocation. In preferred embodiments, X=phi/pi, where phi=(1+sqrt(5))/2. The disclosed framework provides a unified, reusable, and standards-agnostic control architecture across multiple wireless subsystems.

### CROSS-REFERENCE TO RELATED APPLICATIONS

This application claims the benefit of U.S. Provisional Patent Application No. 63/770,746, filed Mar. 12, 2025, titled “Recognition-Modulated Wireless Communication System: Explicit Methods and Systems for Optimized Wireless Communication via Recognition Physics Principles”, the entire disclosure of which is incorporated herein by reference.

### INCORPORATION BY REFERENCE

Each U.S. patent and U.S. patent application publication cited herein, if any, is incorporated by reference in its entirety. Any non-patent literature cited herein, if any, is incorporated by reference only for non-essential background information and not for any material that is necessary to satisfy the written description or enablement requirements.

### BACKGROUND

The present disclosure relates generally to wireless communication systems and, more particularly, to systems, devices, methods, and computer-implemented control architectures for adaptively controlling wireless transmission, reception, estimation, coding, beamforming, scheduling, and related operating parameters in response to measured, estimated, or computed wireless performance metrics.

Wireless communication platforms have become increasingly heterogeneous in both architecture and operating environment. Modern implementations may include, by way of example and not limitation, transmitters, receivers, transceivers, repeaters, relays, access points, base stations, distributed radio units, user equipment, satellite terminals, vehicle nodes, unmanned-system radios, tactical radios, IoT endpoints, low-power sensor nodes, and mesh-network devices. Such platforms may operate across different waveform families, air interfaces, and deployment models, including terrestrial, non-terrestrial, fixed, mobile, ad hoc, and infrastructure-based networks.

Many wireless systems rely on layered and partially independent control functions spanning digital baseband processing, RF front ends, antenna systems, channel estimation, modulation selection, coding selection, link adaptation, packet scheduling, retransmission control, and network-level resource assignment. These functions are often implemented using different local metrics, distinct update intervals, and subsystem-specific thresholds. As a result, overall system behavior can become fragmented, difficult to coordinate, and inefficient under changing channel and traffic conditions.

One recurring limitation in conventional wireless systems is power inefficiency in closed-loop control arrangements, such as target-SINR or related link-maintenance loops. In many implementations, transmit power is increased or decreased using threshold-based or table-based heuristics that do not smoothly reflect underlying channel quality or uncertainty. This can lead to unnecessary power expenditure, oscillatory behavior, conservative margins, or degraded battery life, particularly in fading, interference-limited, or mobility-intensive scenarios.

Another limitation arises from spectral-efficiency loss associated with discrete modulation and coding selection mechanisms. Many practical systems choose among a finite set of modulation and coding scheme entries, rate tables, or mode profiles. While operationally convenient, such discrete selection can create coarse operating transitions, underutilize usable channel capacity, and force a system into unnecessarily conservative or unstable operating points when actual link conditions lie between table entries.

Channel estimation itself remains a significant source of performance degradation. Wireless channels are commonly estimated from pilots, reference symbols, training fields, or sounding procedures, but such estimates may be corrupted by thermal noise, interference, quantization effects, pilot contamination, oscillator impairments, phase noise, timing offsets, Doppler, hardware non-idealities, or insufficient observation density. Inaccurate channel-state information can propagate into equalization, soft demapping, decoding, beamforming, link adaptation, and scheduling decisions, thereby compounding performance loss across multiple layers.

Beamforming and antenna-array control are likewise sensitive to channel-state-information error and related uncertainty. In single-user and multi-user multiple-antenna systems, inaccuracies in channel estimation, covariance estimation, beam scoring, or interference prediction can degrade beam selection, precoding, combining, null steering, sidelobe management, and spatial multiplexing performance. These effects may be especially pronounced in mmWave, massive-MIMO, satellite, vehicular, and rapidly time-varying deployments.

Coding and error-protection mechanisms introduce further tradeoffs. To maintain reliability, conventional systems often add redundancy through stronger coding, retransmissions, repetition, or conservative HARQ settings. However, excessive redundancy reduces effective throughput, increases latency, consumes bandwidth, and may raise energy consumption. Conversely, aggressive rate selection may increase error rates and retransmission load. Existing techniques often rely on fragmented heuristics rather than a unified control framework capable of coordinating reliability and efficiency across operating conditions.

Conventional architectures also suffer from parameter proliferation across subsystems. Separate modules may each maintain their own thresholds, weights, margins, lookup tables, damping constants, switching criteria, and fallback rules for modulation, coding, power, beam management, synchronization, packet scheduling, and admission or routing decisions. The resulting design burden increases implementation complexity, verification cost, tuning effort, and field-maintenance difficulty, while also making it harder to predict global system behavior.

A further issue is cross-layer inconsistency. In many implementations, PHY, MAC, RF, and network-level controllers optimize different objectives using different decision variables and different threshold structures. For example, one subsystem may prioritize throughput, another may prioritize reliability, another may prioritize energy consumption, and another may prioritize latency or fairness. Because these objectives are often pursued using independently tuned control laws, the resulting actions may conflict, producing unstable or suboptimal end-to-end behavior.

Another recurring problem is the presence of mode-switch cliff effects. In many wireless systems, performance changes abruptly when a metric crosses a threshold associated with a mode boundary, MCS boundary, retransmission rule, beam-selection state, or scheduler classification. Such abrupt transitions may produce discontinuities in throughput, latency, packet error performance, or control stability, even where the underlying channel or traffic conditions change only gradually. This can be particularly problematic in mobile environments, burst-interference environments, handover regions, and mixed-service networks.

These issues are not confined to any single waveform or standard. Similar control limitations can arise in systems employing OFDM, OFDMA, DFT-s-OFDM, SC-FDMA, single-carrier signaling, OTFS, spread-spectrum signaling, mesh-network protocols, non-terrestrial-network architectures, WiFi systems, LPWAN systems, V2X systems, and other present or future wireless technologies. Accordingly, there remains a need for wireless control techniques that are standards-agnostic, scalable across device classes and network topologies, and adaptable across multiple subsystems without being restricted to a single protocol family.

There is therefore a need for improved wireless communication architectures that can use measured, estimated, or computed performance-related quantities in a more unified and controllable manner across transmission, reception, estimation, coding, beamforming, scheduling, and related functions. There is also a need for approaches that reduce reliance on brittle thresholding behavior, lessen subsystem fragmentation, and support coordinated adaptation across multiple layers and resources.

The foregoing discussion is intended only to illustrate example technical problems encountered in existing wireless systems and should not be treated as an admission that any particular subject matter described herein constitutes prior art to the claimed invention.

### SUMMARY OF THE INVENTION

In various embodiments, the present disclosure provides a wireless communication apparatus, system, method, and non-transitory computer-readable medium configured to acquire, receive, derive, estimate, or compute at least one recognition metric associated with a wireless condition, signal, channel, interference environment, beam state, user state, stream state, codeword state, or network state. In preferred implementations, the recognition metric is non-negative and dimensionless, or is converted into a non-negative normalized form suitable for use in a bounded monotone mapping framework.

In various embodiments, the apparatus, system, method, or non-transitory computer-readable medium computes from the recognition metric r a bounded monotone recognition coefficient according to a mapping of the form:

### F_cov(r)=r/(r+X),

where X is a positive constant. In broader embodiments, X may be predetermined, stored, provisioned, configured, learned, calculated, transmitted, updated, or otherwise supplied. The resulting recognition coefficient may then be used, either directly or indirectly, to control at least one wireless operating parameter.

In various embodiments, the bounded monotone recognition coefficient provides a technical control advantage over threshold-based or table-based techniques by producing a smooth, numerically bounded control weight that reduces oscillation, reduces abrupt mode-switch transitions, and supports predictable constraint enforcement when applied to transmitter, receiver, beamforming, coding, retransmission, scheduling, or cross-layer resource allocation operations implemented in modem processing circuitry.

In various embodiments, the wireless operating parameter controlled using the recognition coefficient may include, without limitation, a transmission parameter, reception parameter, channel-estimation parameter, equalization parameter, synchronization parameter, modulation parameter, constellation-shaping parameter, coding parameter, decoding parameter, retransmission parameter, power-control parameter, antenna parameter, beamforming parameter, precoding parameter, combining parameter, scheduling parameter, handover parameter, multi-link selection parameter, routing parameter, interference-management parameter, or cross-layer resource-allocation parameter. Accordingly, the disclosure is not limited to one subsystem, but instead supports reuse of a common mapping framework across transmitter-side, receiver-side, RF-side, array-side, and network-side control functions.

In one abstraction tier, the present disclosure provides a recognition mapping engine that can be instantiated in any one wireless subsystem that uses the bounded monotone map. In another abstraction tier, the present disclosure provides a shared-constant multi-subsystem architecture in which one constant is used across two or more wireless subsystems so that different adaptation functions can be coordinated using a common recognition framework. In a further abstraction tier, the present disclosure provides a preferred full-stack embodiment in which a common recognition constant is reused across multiple wireless layers and control paths.

In preferred embodiments, the constant X is selected as:

### X_opt=phi/pi,

where:
   phi=(1+sqrt(5))/2.

In further preferred embodiments, this constant is used as a parameter-free recognition constant within a recognition-structure framework. In some embodiments, the preferred constant is associated with the cost function:

### J(x)=1/2*(x+x\hat{ }−1)−1.

The disclosure, however, is not limited to only that provenance, and broader embodiments expressly include use of a stored design constant or other positive constant in the same mapping family.

In various embodiments, the disclosure expressly encompasses both direct-map and inverse-map control families. In direct-map embodiments, a control variable is based on:

### F_cov(r)=r/(r+X_opt),

such that the control variable increases as the quality-related metric improves. In inverse-map embodiments, a control variable is based on the complement:

### F_comp(r)=1−F_cov(r)=X_opt/(r+X_opt),

such that the control variable decreases as the quality-related metric improves, or increases as uncertainty, noise, impairment, interference, or error risk increases. This dual disclosure supports use of one formula family for both quality-following control and risk-responsive control.

In various embodiments, the recognition metric r may be formed from one or more measured, estimated, detected, decoded, inferred, aggregated, filtered, averaged, or predicted quantities. The metric may be represented as a scalar, vector, matrix, tensor, time series, block-aggregated sequence, per-subcarrier set, per-user set, per-beam set, or per-link set. Thus, the disclosure supports operation at different granularities, including per-resource, per-subcarrier, per-carrier, per-antenna, per-subarray, per-stream, per-codeword, per-user, per-beam, per-link, and network-wide granularities.

In various embodiments, the disclosed subject matter may be implemented in hardware, firmware, software, or combinations thereof, including DSP, FPGA, ASIC, processor-executed, accelerator-based, distributed, centralized, cloud-assisted, and node-local implementations. The disclosed subject matter is further applicable across multiple wireless technologies and deployment environments, and is not limited to any particular waveform, protocol, air interface, network topology, or standards family. Accordingly, the present disclosure provides a unified, reusable, and standards-agnostic control framework for wireless adaptation using bounded monotone recognition mapping.

This Summary is provided to introduce selected concepts in simplified form and is not intended to identify every disclosed feature or to limit the scope of the claimed subject matter. Additional features, embodiments, implementations, examples, variations, and advantages are described in the following sections and illustrated in the accompanying drawings.

### BRIEF DESCRIPTION OF THE DRAWINGS

The accompanying drawings, which are incorporated herein and form a part of the specification, illustrate exemplary embodiments of the present disclosure and, together with the description, serve to explain principles of the disclosed subject matter. The drawings are provided for purposes of illustration and description and are not intended to limit the scope of the claimed invention.

FIG. 1 is a schematic diagram of an overall wireless communication system architecture including one or more wireless nodes, at least one recognition mapping engine, and one or more controlled wireless subsystems configured to apply recognition-based control to transmission, reception, estimation, coding, beamforming, scheduling, or network operations.

FIG. 2 is a functional block diagram of a recognition mapping engine configured to receive or derive at least one recognition metric, compute a bounded monotone recognition coefficient, and output one or more control values for use by one or more wireless subsystems.

FIG. 3 is a flow diagram of a transmitter-side recognition-based control process in which one or more recognition coefficients are used to control at least one transmission parameter associated with power, modulation, coding, waveform selection, shaping, precoding, beam selection, or resource usage.

FIG. 4 is a flow diagram of a receiver-side recognition-based process in which one or more recognition coefficients are used in channel estimation, equalization, synchronization, soft demapping, decoding support, or related reception operations.

FIG. 5 is a schematic diagram of a closed-loop feedback arrangement in which recognition-related information or derived control information is fed back between receiver-side and transmitter-side functions to adapt operation over time.

FIG. 6 is a diagram illustrating direct-map and inverse-map control families, including use of a bounded monotone recognition coefficient when a control variable should increase as a quality metric improves and use of a complementary coefficient when a control variable should increase as uncertainty, impairment, or risk increases.

FIG. 7 is a schematic and functional diagram of a recognition-based channel-estimation and equalization embodiment in which channel estimates, equalizer values, confidence values, or soft information are adjusted using elementwise or otherwise applied recognition coefficients.

FIG. 8 is a schematic diagram of a recognition-optimized antenna-array and beamforming embodiment including array geometry, element spacing, element weighting, beam management, or hybrid analog/digital beamforming control using recognition-based coefficients.

FIG. 9 is a schematic and flow diagram of a recognition-based coding and retransmission embodiment in which recognition-related quantities are used to influence coding strength, puncturing, shortening, retransmission selection, HARQ behavior, or related reliability-control functions.

FIG. 10 is a schematic and flow diagram of a recognition-based scheduling and link-selection embodiment in which recognition-related quantities are used to control resource assignment, OFDMA scheduling, user selection, dual-connectivity selection, or multi-link communication decisions.

FIG. 11 is a schematic diagram of an implementation architecture showing example hardware and software realizations of the disclosed subject matter, including processor-based, DSP-based, FPGA-based, ASIC-based, or distributed network-control implementations.

FIG. 12 is a schematic diagram showing example deployment contexts in which the disclosed recognition-based wireless control techniques may be used, including one or more of a base station, user equipment device, IoT node, satellite communication node, vehicle node, or other wireless platform.

### DETAILED DESCRIPTION

The following detailed description sets forth illustrative embodiments of the disclosed subject matter in sufficient detail to enable a person of ordinary skill in the art to make and use the invention. The described embodiments are examples and are not intended to limit the claimed subject matter. Unless the context requires otherwise, functions described as being performed by a subsystem, engine, controller, circuit, processor, or module may be implemented in hardware, firmware, software, or combinations thereof. Likewise, a recognition metric may be measured, estimated, derived, inferred, filtered, averaged, normalized, or otherwise obtained from one or more wireless observations, and may be represented as a scalar, vector, matrix, tensor, time series, per-resource value, per-user value, per-beam value, per-link value, or other form suitable for control use.

As used herein, a “recognition metric” means a non-negative quantity derived from one or more wireless observations, measurements, estimates, decoded quantities, inferred quantities, filtered quantities, predicted quantities, or combinations thereof, and usable to generate a bounded monotone control coefficient for a wireless function. A recognition metric may correspond to a quality-related quantity, a risk-related quantity, an uncertainty-related quantity, an impairment-related quantity, an interference-related quantity, a decoder-related quantity, a queue-related quantity, a load-related quantity, or another wireless-performance-related quantity. A recognition metric may be represented as a scalar, vector, matrix, tensor, time series, block-aggregated sequence, per-subcarrier set, per-resource set, per-user set, per-beam set, per-stream set, per-codeword set, or per-link set.

As used herein, a “recognition coefficient” means a bounded monotone coefficient computed from a recognition metric using the mapping described herein or a complementary form thereof. A “recognition mapping engine” means circuitry, logic, firmware, software, or combinations thereof configured to compute the recognition coefficient and optionally a complementary recognition coefficient for use by one or more wireless subsystems. A “quality metric” refers to a metric for which improvement in the underlying wireless condition corresponds to an increase in the desired control-driving quantity. A “risk metric” refers to a metric for which an increase in uncertainty, impairment, interference, error likelihood, or related adverse condition corresponds to an increase in a protective or compensating control-driving quantity.

As used herein, a “wireless node” includes a transmitter, receiver, transceiver, repeater, relay, access point, base station, distributed radio unit, user equipment device, satellite terminal, vehicle node, IoT node, tactical radio, mesh node, or other wireless platform. A “resource unit” includes a subcarrier, tone group, resource element, resource block, slot, symbol group, beam resource, codeword resource, carrier, layer, stream, user allocation, or other schedulable or controllable wireless resource. A “beam” includes an analog beam, digital beam, hybrid beam, subarray beam, eigenmode beam, or other spatial transmission or reception pattern. A “spatial stream” includes one of multiple simultaneously transmitted or received layers or streams in a multiple-antenna system. A “codeword” includes a coded block, transport block, packet payload coding unit, HARQ process unit, or other error-protected unit. A “pilot” or “reference signal” includes a pilot symbol, sounding signal, training sequence, synchronization sequence, or other known signal component used in estimation, equalization, synchronization, or control.

Unless expressly stated otherwise, an embodiment described herein may be a measured embodiment, a simulated embodiment, a within-model verified embodiment, or a prophetic embodiment. Reference to a preferred theoretical provenance for a constant or mapping does not require that every implementation rely on that provenance, and operational wireless embodiments may be practiced using the disclosed mapping framework whether or not the preferred provenance is used for implementation justification.

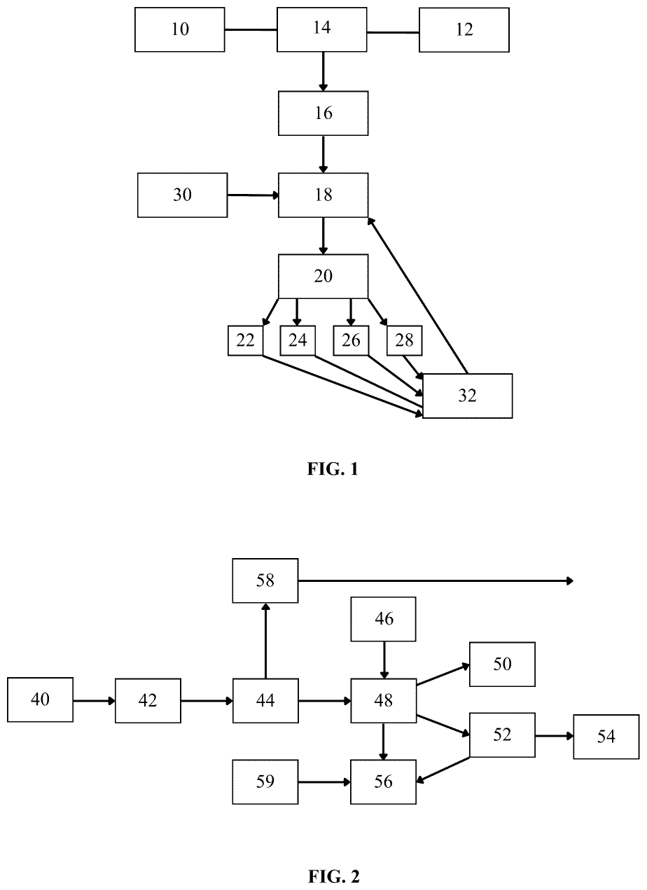

FIG. 1 illustrates an overall wireless communication system architecture including a first wireless node 10, a second wireless node 12, a wireless channel 14 between the nodes, metric acquisition circuitry 16, a recognition mapping engine 18, a coefficient output path 20, a transmitter control subsystem 22, a receiver control subsystem 24, a beamforming control subsystem 26, a scheduling and cross-layer control subsystem 28, a configuration memory 30, and a feedback interface 32. In various embodiments, the first wireless node 10 and the second wireless node 12 may each be implemented as a base station, access point, user equipment device, relay, repeater, satellite terminal, vehicle node, tactical radio, IoT device, mesh node, or other wireless platform. The metric acquisition circuitry 16 obtains one or more recognition metrics from wireless observations associated with the wireless channel 14, transmitted or received signals, local device state, link state, or network state.

In the embodiment of FIG. 1, the recognition mapping engine 18 receives at least one recognition metric from the metric acquisition circuitry 16 and computes one or more bounded monotone recognition coefficients that are delivered on the coefficient output path 20 to one or more controlled wireless subsystems. The transmitter control subsystem 22 may use the recognition coefficient to control modulation, waveform selection, transmission power, pilot boosting, shaping, precoding, or related transmission parameters. The receiver control subsystem 24 may use the recognition coefficient to control channel estimation, equalization, synchronization, soft demapping, decoding support, or related reception parameters. The beamforming control subsystem 26 may use the recognition coefficient to control element spacing, array weighting, beam selection, beam refinement, null steering, or interference suppression. The scheduling and cross-layer control subsystem 28 may use the recognition coefficient to control resource assignment, user ranking, handover, dual connectivity, multi-link selection, routing, or related control actions. The configuration memory 30 may store a positive mapping constant, normalization parameters, clipping thresholds, fallback settings, or standards-compliance parameters, and the feedback interface 32 may receive return-path measurements or control information for closed-loop adaptation.

FIG. 2 illustrates a recognition mapping engine including an input interface 40, a normalization block 42, a metric register 44, a constant store 46, a mapping computation block 48, a direct-map output 50, a complement computation block 52, an inverse-map output 54, a limiter and clipping block 56, a bypass path 58, and a watchdog and fail-safe block 59. The input interface 40 receives one or more recognition metrics, which may be represented in linear form, logarithmic form, normalized form, or converted form. The normalization block 42 converts the received metric into a non-negative form suitable for bounded monotone mapping. The metric register 44 stores the normalized recognition metric r, and the constant store 46 stores a positive constant X. In preferred embodiments, the positive constant X is equal to X_opt=phi/pi, where phi=(1+sqrt(5))/2. In broader embodiments, the positive constant X may be predetermined, provisioned, stored, configured, calibrated, or otherwise supplied.

In the embodiment of FIG. 2, the mapping computation block 48 computes a direct recognition coefficient according to F_cov(r)=r/(r+X), and the direct recognition coefficient is made available at the direct-map output 50. The complement computation block 52 computes an inverse or complementary coefficient according to F_comp(r)=1−F_cov(r)=X/(r+X), and the complementary coefficient is made available at the inverse-map output 54. The limiter and clipping block 56 may enforce numerical bounds, quantization limits, saturation limits, or regulatory control limits. The bypass path 58 may be used to disable recognition-based control and fall back to a legacy or standards-defined mode. The watchdog and fail-safe block 59 may monitor arithmetic validity, range validity, or control stability and may trigger fallback behavior if an error, out-of-range condition, or unsafe operating condition is detected. The mapping computation block 48 may be implemented using a divider, reciprocal lookup table, CORDIC-based approximation, polynomial approximation, fixed-point arithmetic, floating-point arithmetic, pipelined datapath, time-multiplexed datapath, or vectorized datapath.

For any non-negative recognition metric r and positive constant X, the mapping F_cov(r)=r/(r+X) is bounded and monotone increasing, such that 0<=F_cov(r)<1 for r>=0, lim r->0 F_cov(r)=0, and lim r->infinity F_cov(r)=1. The derivative satisfies dF_cov/dr=X/(r+X)\hat{ }2, which is positive for X>0 and r>=0. The complementary form satisfies F_comp(r)=1 F_cov(r)=X/(r+X). In implementations that reconstruct or estimate a recognition metric from a coefficient value, the relation may be inverted as r=X*F_cov/(1−F_cov). These properties support use of the mapping as a smooth bounded control law for direct-map and inverse-map wireless adaptation.

In practical wireless implementations, the bounded monotone recognition coefficients provide a concrete technical improvement in modem and network control by converting noisy, time-varying measurement inputs into smooth, numerically bounded control weights that can be applied across transmitter, receiver, beamforming, coding, retransmission, and scheduling functions. Because the coefficients are bounded and monotone, control actions based on F_cov(·) and/or F_comp(·) can reduce oscillation and instability associated with hard thresholding, can mitigate mode-switch cliff effects by providing continuous transitions between operating points, and can simplify constraint enforcement by ensuring the control weight remains within a predictable numeric range. In various embodiments, the mapping is implemented in baseband processing circuitry (e.g., DSP/ASIC/FPGA) as a pipelined datapath or lookup-based computation with clipping/limiting and watchdog fallback, such that recognition-modulated control is executed as part of the physical-layer or MAC-layer processing pipeline rather than as an abstract calculation divorced from hardware operation.

By way of non-limiting example, a recognition metric may be formed from measured or estimated wireless quantities using normalization or conversion operations suited to the quantity being used. Example forms include r_snr=10\hat{ }(SNR_dB/10), r_sinr=10\hat{ }(SINR_dB/10), r_ber=1/BER, r_bler=1/BLER, r_per=1/PER, r_evm=1/EVM_rms, r_delay=1/tau_rms, and r_interf=1/I_norm when lower interference corresponds to better link quality. Additional example metric sources include channel-tap energy, delay spread, Doppler spread, queue depth, latency urgency, thermal headroom, battery headroom, decoder confidence, LLR magnitude, beam score, covariance eigenvalue, singular value, and load state. A metric may be instantaneous, filtered, averaged, median-based, smoothed, clipped, windowed, calibrated, or otherwise conditioned before application of the bounded monotone mapping.

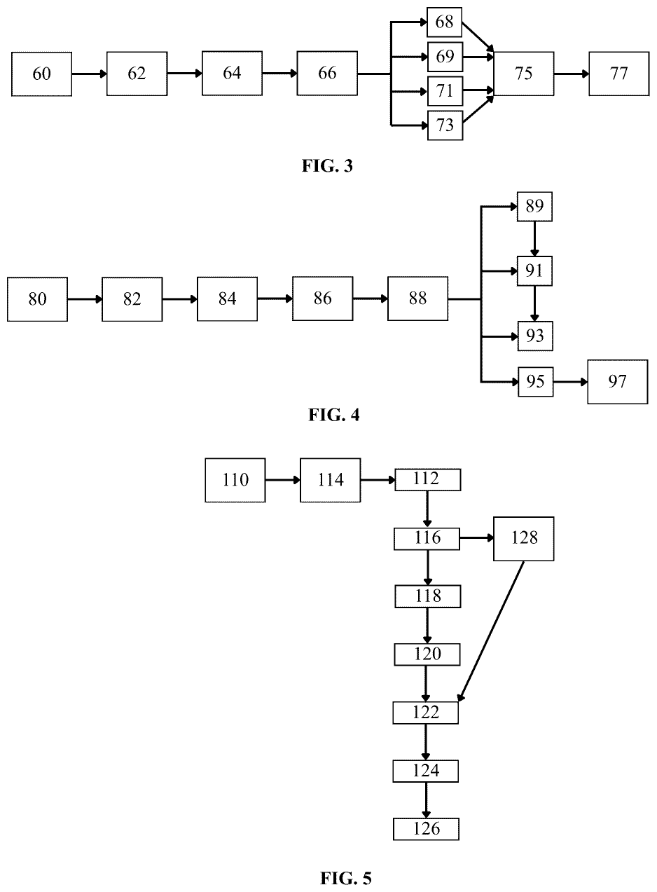

FIG. 3 illustrates a transmitter-side control process including a transmitter metric input 60, a normalization stage 62, a recognition mapping stage 64, a map-selection stage 66, a modulation-control output 68, a power-control output 69, a waveform and resource-control output 71, a beam and precoding-control output 73, a compliance and constraint block 75, and a transmitter chain 77. The transmitter metric input 60 may receive one or more transmitter-relevant recognition metrics, including metrics derived from SNR, SINR, BER target, BLER target, EVM, interference level, battery headroom, thermal headroom, queue urgency, or other transmitter-relevant quantities. The normalization stage 62 converts one or more such quantities into a non-negative recognition metric. The recognition mapping stage 64 computes a direct coefficient, a complementary coefficient, or both. The map-selection stage 66 selects whether the current transmitter control law should follow direct-map behavior or inverse-map behavior.

In the embodiment of FIG. 3, the modulation-control output 68 may apply a recognition coefficient to a phase, amplitude, constellation radius, shaping scale, modulation order, pilot level, subcarrier selection, resource-block selection, or per-layer transmission parameter. For example, a recognition-modulated phase may be expressed as theta_RM(t)=theta(t)*F_cov(r_snr(t)), and a corresponding transmitted signal may be expressed as s_RM(t)=A(t)*exp(j*[2*pi*f_c*t+theta_RM(t)]). In amplitude-related embodiments, an adjusted amplitude may be expressed as A_RM=A_base*F_cov(r_amp). The power-control output 69 may implement direct or inverse power control, including P_tx_direct(t)=P_max*F_cov(1/BER_target)*F_cov(r_snr(t)), P_tx_inverse(t)=P_min+(P_max−P_min)*F_comp(r_snr(t)), or a hybrid form such as P_floor+(P_ceiling−P_floor)*F_comp(r_snr(t))*F_cov(1/BER_target). The waveform and resource-control output 71 may apply recognition coefficients per subcarrier, per resource block, per spatial layer, per beam, or per user. The beam and precoding-control output 73 may apply recognition-based scaling to precoding, beam selection, or tone nulling. The compliance and constraint block 75 may enforce PA linearity, ACLR or spectral mask limits, SAR limits, thermal limits, battery limits, duty-cycle limits, and other transmitter constraints before the adjusted settings are applied by the transmitter chain 77.

FIG. 4 illustrates a receiver-side process including a received-signal input 80, a pilot and reference extractor 82, a channel-estimation block 84, an uncertainty-metric extractor 86, a receiver-side recognition mapper 88, an equalization block 89, a soft-demapping block 91, a decoding-support interface 93, a synchronization block 95, and a receiver adaptation output 97. The received-signal input 80 receives a wireless signal and delivers the received waveform to downstream receiver operations. The pilot and reference extractor 82 obtains pilots, reference signals, sounding sequences, or other known structures from the received waveform. The channel-estimation block 84 computes an initial or raw channel estimate H0, and the uncertainty-metric extractor 86 computes a metric related to uncertainty, noise, impairment, interference, or reliability of the estimate.

In the embodiment of FIG. 4, the receiver-side recognition mapper 88 computes a recognition coefficient that is used by the equalization block 89, the soft-demapping block 91, the decoding-support interface 93, the synchronization block 95, or combinations thereof. In one channel-estimation embodiment, a weighted channel estimate may be expressed as H_hat(f,t)=H0(f,t)*F_cov(|H0(f,t)|\hat{ }2). In an elementwise matrix embodiment, a weighted channel estimate may be expressed as H_hat=H0.*F_cov(|H0|\hat{ }2) where the mapping is applied elementwise. In an uncertainty-weighted embodiment, a weighted estimate may be expressed as H_hat=H0*F_comp(U_H), where U_H is an uncertainty metric. The equalization block 89 may form MMSE, ZF, or decision-feedback equalizer parameters from the weighted estimate. The soft-demapping block 91 may use recognition-based LLR scaling or confidence weighting. The decoding-support interface 93 may deliver recognition-weighted soft information or iteration-control information to a decoder. The synchronization block 95 may use recognition-based control for carrier-frequency-offset correction, timing-offset correction, phase-noise tracking, Doppler adaptation, or pilot-density adaptation. The receiver adaptation output 97 may provide control information for local use or for feedback transmission.

FIG. 5 illustrates a closed-loop feedback arrangement including a transmitter 110, a receiver 112, a forward wireless link 114, a receiver measurement block 116, a feedback metric packet generator 118, a feedback channel 120, a recognition controller 122, an update scheduler 124, a control command output 126, and a reliability-status signal 128. The transmitter 110 sends a waveform over the forward wireless link 114, and the receiver 112 evaluates one or more received-signal conditions using the receiver measurement block 116. The receiver measurement block 116 may generate one or more recognition metrics or one or more quantities from which recognition metrics may be derived. The feedback metric packet generator 118 formats, compresses, quantizes, or otherwise prepares such information for return over the feedback channel 120.

In the embodiment of FIG. 5, the recognition controller 122 receives feedback information and computes updated control values for subsequent transmissions. The update scheduler 124 determines when the control values are applied, which may be on a symbol basis, slot basis, packet basis, frame basis, beam-update basis, or other timing basis. The control command output 126 may update transmission power, modulation settings, coding settings, beam settings, resource assignment, or other transmitter-side operating parameters. The reliability-status signal 128 may include ACK, NACK, error-rate information, confidence information, or other return-path indicators usable for adaptation. The feedback channel 120 may be explicit or implicit, analog or digital, quantized or unquantized, and may carry instantaneous, filtered, averaged, windowed, or event-triggered information. The closed-loop arrangement may thereby support iterative recognition-based adaptation over time while preserving compatibility with systems that require bounded control adjustments and stable update timing.

In one implementable closed-loop embodiment, the receiver computes, for each update interval, (i) an estimated SINR in linear units from measured pilot and data symbols, (ii) a block error rate estimate BLER_est over a sliding window of W blocks, and (iii) a recognition metric r_sinr=SINR_lin and optionally r_bler=1/max(BLER_est, ε), where ε is a small positive floor. The receiver computes a recognition coefficient F_cov(r_sinr)=r_sinr/(r_sinr+X) and optionally a reliability coefficient F_cov(r_bler)=r_bler/(r_bler+X). The transmitter updates transmit power once per T slots using P_tx=clamp(P_min, P_max, P_min+(P_max−P_min)·F_comp(r_sinr)), where F_comp(r_sinr)=X/(r_sinr+X). Decision rule: if BLER_est exceeds a target BLER_target for K consecutive windows, the transmitter increases pilot density or coding strength for at least one subsequent window; otherwise it decreases pilot density or increases code rate subject to constraints. Verification metric: compliance is satisfied when BLER_est≤BLER_target over at least M consecutive windows while maintaining a throughput above a configured minimum.

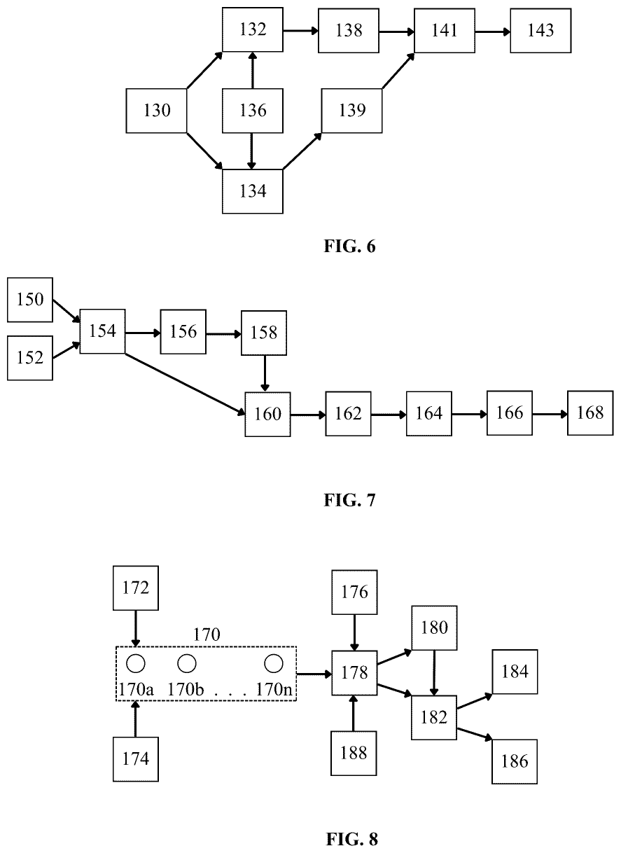

FIG. 6 illustrates direct-map and inverse-map control families including a quality-metric input 130, a direct-map branch 132, an inverse-map branch 134, a constant input 136, a direct-control output 138, a risk-responsive control output 139, a map-selection block 141, and a controlled-parameter actuator 143. The quality-metric input 130 receives a non-negative recognition metric r. The constant input 136 provides a positive constant X, which in preferred embodiments is X_opt=phi/pi. The direct-map branch 132 computes F_cov(r)=r/(r+X), and the inverse-map branch 134 computes F_comp(r)=1−F_cov(r)=X/(r+X).

In the embodiment of FIG. 6, the direct-control output 138 is used when a controlled parameter is intended to increase as the corresponding quality metric improves. The risk-responsive control output 139 is used when a controlled parameter is intended to increase as uncertainty, impairment, interference, or error risk increases, or to decrease as quality improves. The map-selection block 141 may choose between the two branches on a per-parameter basis, per-resource basis, per-link basis, or per-control-cycle basis. The controlled-parameter actuator 143 may apply either branch to a modulation variable, a rate variable, a beam variable, a power variable, a retransmission variable, a scheduling score, or another wireless operating parameter. This arrangement supports a single formula family that can be reused for both quality-following control and risk-responsive control without changing the underlying recognition-mapping framework.

FIG. 7 illustrates a recognition-based channel-estimation and equalization embodiment including a received waveform input 150, pilot symbols 152, a raw channel-estimation block 154, a metric extractor 156, a channel-side recognition mapper 158, a weighted channel-estimate output 160, an equalizer-coefficient generator 162, a soft-demapper 164, an LLR-scaling block 166, and a decoder interface 168. The raw channel-estimation block 154 computes an initial channel estimate H0 from the received waveform input 150 and the pilot symbols 152. The metric extractor 156 derives one or more recognition metrics from channel energy, tap magnitude, covariance information, pilot reliability, estimation variance, interference level, or similar channel-related observations. The channel-side recognition mapper 158 computes one or more recognition coefficients from the derived metric.

In the embodiment of FIG. 7, the weighted channel-estimate output 160 may be formed according to H_hat=H0.*F_cov(|H0|\hat{ }2), where the mapping is applied elementwise to channel-estimate magnitudes or energies. In another embodiment, the weighted channel-estimate output 160 may be formed according to H_hat=H0*F_comp(U_H), where U_H represents a channel-uncertainty measure. The equalizer-coefficient generator 162 may compute MMSE, ZF, or other equalization coefficients using the weighted channel estimate. The soft-demapper 164 may generate symbol decisions or soft information using equalized observations. The LLR-scaling block 166 may apply recognition-based weighting to log-likelihood ratios, confidence values, or decoding metrics. The decoder interface 168 may supply such values to a decoder for improved reliability handling, iteration control, early stopping, or other decoding-related functions.

FIG. 8 illustrates a recognition-optimized antenna-array and beamforming embodiment including an antenna array 170 having antenna elements 170a through 170n, an element-spacing parameter 172, a panel-geometry definition 174, a beam-score input 176, a recognition weighting block 178, an analog beamformer 180, a digital precoder or combiner 182, a weighted beam output 184, a sidelobe and null-control output 186, and a covariance or eigenmode input 188. The antenna array 170 may be linear, planar, circular, cylindrical, conformal, subarrayed, hybrid analog-digital, distributed, satellite-based, or reflect-array-assisted. The panel-geometry definition 174 may specify element positions, panel arrangement, subarray grouping, aperture shape, or related array geometry parameters.

In the embodiment of FIG. 8, the element-spacing parameter 172 may be selected according to d=(lambda/2)*X_opt in a preferred spacing embodiment. The beam-score input 176 may provide one or more recognition-relevant quantities based on beam quality, covariance values, eigenvalues, singular values, interference levels, or beam-search results. The recognition weighting block 178 may compute element, subarray, beam, or eigenmode weights. In one embodiment, an element weight may be expressed as w_n=w0_n*F_comp(rho_n). In another embodiment, a weight vector may be expressed as w=w0*F_comp(rho). In another embodiment, a beamforming matrix may be expressed as W=W0*diag(F_comp(rho_n)). The analog beamformer 180 and the digital precoder or combiner 182 may apply such weights to support beam search, beam refinement, beam tracking, beam handoff, sidelobe control, null steering, interference suppression, or multi-user beam management. The weighted beam output 184 and the sidelobe and null-control output 186 may thereby implement recognition-based spatial control over an array response.

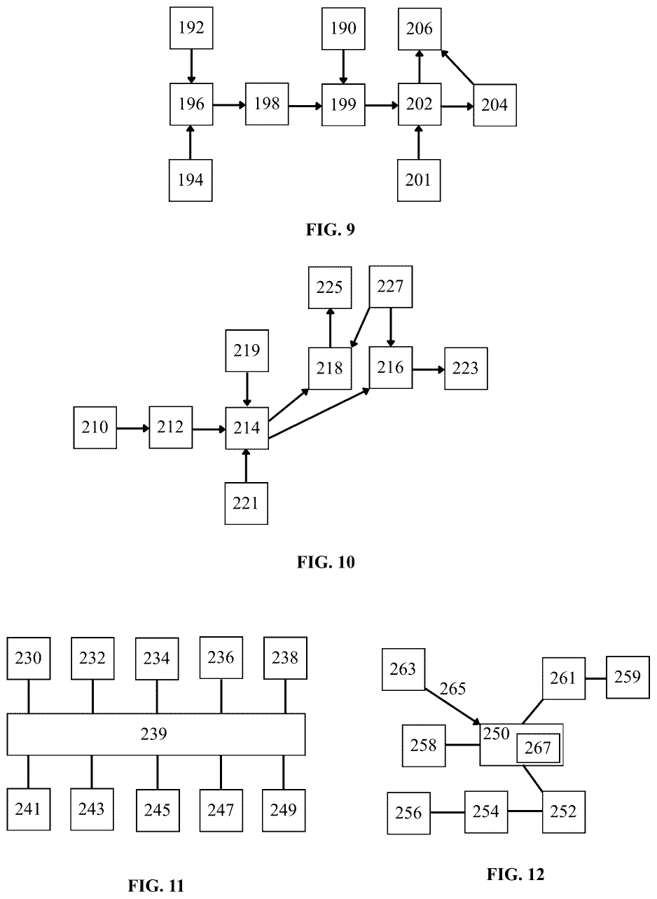

FIG. 9 illustrates a recognition-based coding and retransmission embodiment including an information-bit input 190, a code-parameter input 192, a recognition-metric input 194, a rate-computation block 196, a puncturing and shortening block 198, an encoder 199, a decoder-confidence input 201, a HARQ controller 202, a combining-weight block 204, and a retransmission-control output 206. The recognition-metric input 194 may be derived from codeword quality, decoder confidence, channel condition, error rate, or related reliability measurements. The rate-computation block 196 may compute an adjusted code parameter from the recognition metric.

In the embodiment of FIG. 9, a recognition-related code quantity may be expressed as E(n,k)=k*F_cov(n/k). In another embodiment, an effective code rate may be expressed as R_eff=R_min+(R_max-R_min)*F_cov(r_code), and a corresponding effective code length may be expressed as n_eff=ceil(k/R_eff). The puncturing and shortening block 198 may implement recognition-driven puncturing, shortening, parity selection, frozen-bit selection, parity-check activation, or related coding actions. The encoder 199 may be configured for LDPC, Polar, turbo, convolutional, BCH, Reed-Solomon, fountain, rateless, or network-coding families. The decoder-confidence input 201 may supply LLR magnitude, confidence, iteration state, or decoding-success metrics to the HARQ controller 202. The HARQ controller 202 may adjust retransmission aggressiveness, repetition count, combining mode, or ACK/NACK handling. The combining-weight block 204 may assign combining weights for retransmitted information based on recognition coefficients. The retransmission-control output 206 may thereby coordinate coding and retransmission as a unified recognition-based reliability-control process.

FIG. 10 illustrates a recognition-based scheduling and link-selection embodiment including a metric-collection input 210, a user or link state table 212, a recognition scoring engine 214, a resource allocator 216, a handover and multi-link selector 218, a queue and latency input 219, an interference and load input 221, a schedule output 223, a selected-link output 225, and a policy and constraint memory 227. The metric-collection input 210 receives per-user, per-link, per-resource, or network-level recognition metrics. The user or link state table 212 stores such metrics together with associated user identifiers, link identifiers, beam identifiers, resource identifiers, latency values, or service values. The queue and latency input 219 and the interference and load input 221 may contribute additional recognition-related quantities for cross-layer control.

In the embodiment of FIG. 10, the recognition scoring engine 214 computes one or more decision scores for use by the resource allocator 216 and the handover and multi-link selector 218. Example score forms include Score_j=product over i of F_cov(r_i,j), Score_j=min_i F_cov(r_i,j), and Score_j=average_i F_cov(r_i,j). The resource allocator 216 may apply such scores for OFDMA scheduling, MU-MIMO user ranking, carrier allocation, stream selection, or resource prioritization. The handover and multi-link selector 218 may apply such scores for handover control, dual connectivity selection, carrier aggregation selection, WiFi multi-link operation, relay selection, mesh routing, coordinated multipoint selection, NTN beam hopping, V2X priority handling, or tactical mesh mode selection. The policy and constraint memory 227 may store fairness rules, latency rules, power budgets, service priorities, or standards-related limitations that bound the resulting control actions.

In further embodiments, the recognition scoring engine 214 may compute a joint score using a complement-product aggregation according to R_joint=1−product over i of (1−F_cov(r_i)), which may be used when multiple partially favorable metrics are intended to accumulate into a joint decision value. In some embodiments, the recognition scoring engine 214 receives metrics from PHY, RF, decoder, scheduler, and network-control layers and computes one or more joint scores that resolve competing objectives including reliability, throughput, latency, power consumption, fairness, and interference avoidance within a common recognition-based framework.

FIG. 11 illustrates an implementation architecture including a processor 230, a DSP or accelerator 232, an FPGA or ASIC block 234, a working memory 236, a ROM or configuration store 238, a DMA and interface fabric 239, a radio interface 241, a software API and control stack 243, a telemetry and logging module 245, a watchdog and fail-safe module 247, and a cloud or virtualized control interface 249. The processor 230 may execute supervisory software, protocol software, or higher-level control logic. The DSP or accelerator 232 may implement fast arithmetic operations associated with metric computation, normalization, filtering, or mapping. The FPGA or ASIC block 234 may implement pipelined or dedicated hardware for the recognition mapping engine, signal processing chain, or associated control functions. The ROM or configuration store 238 may hold a preferred constant, normalization parameters, calibration values, or fallback settings. The radio interface 241 may provide access to transmitter and receiver hardware, modem data, channel estimates, beam data, coding data, or scheduler data.

In the embodiment of FIG. 11, the software API and control stack 243 may expose recognition-based control functions to modem software, scheduler software, network-control software, or management software. The DMA and interface fabric 239 may move metric data, control coefficients, tables, or signal data between functional blocks. The telemetry and logging module 245 may record recognition metrics, computed coefficients, selected operating parameters, performance counters, or fallback events for calibration, debugging, or field support. The watchdog and fail-safe module 247 may monitor correctness and stability and may invoke a bypass or fallback mode when needed. The cloud or virtualized control interface 249 may support centralized, distributed, or cloud-assisted control deployments in which recognition-based decisions are made locally, remotely, or cooperatively. The implementation architecture may therefore support ASIC, FPGA, DSP, CPU, software-defined radio, and virtualized deployments without changing the underlying recognition-based control framework.

FIG. 12 illustrates example deployment contexts including a base station 250, a user equipment device 252, an access point 254, an IoT node 256, a satellite communication node 258, a vehicle node 259, a relay or mesh node 261, a remote network controller 263, a wireless backhaul path 265, and a recognition-controlled wireless function 267 disposed in one or more of the depicted platforms. Any one or more of the depicted platforms may host metric acquisition logic, recognition mapping logic, parameter-control logic, or combinations thereof. The recognition-controlled wireless function 267 may operate in a terrestrial cellular network, WiFi network, LPWAN deployment, satellite system, V2X environment, tactical network, relay network, mesh network, fixed wireless system, or mixed-network deployment.

In the embodiment of FIG. 12, control may be performed locally at an endpoint, locally at infrastructure, centrally at the remote network controller 263, or cooperatively between local and remote entities using the wireless backhaul path 265. For example, a base station 250 may use recognition-based control for scheduling, beamforming, coding, or power allocation; a user equipment device 252 may use recognition-based control for uplink transmission, reception, equalization, or link selection; an access point 254 may use recognition-based control for multi-user scheduling or multi-link operation; an IoT node 256 may use recognition-based control for low-power duty-cycled communication; a satellite communication node 258 may use recognition-based control for beam hopping, link adaptation, or power control; a vehicle node 259 may use recognition-based control for high-Doppler or priority traffic conditions; and a relay or mesh node 261 may use recognition-based control for routing, forwarding, or interference-aware operation. The deployment contexts of FIG. 12 demonstrate that the disclosed recognition-based mapping framework is standards-agnostic and usable across multiple wireless node classes and topologies.

In the foregoing embodiments, the disclosed recognition-based control framework may be implemented using a single recognition metric or multiple recognition metrics, and the recognition metric may be represented as a scalar, vector, matrix, tensor, time series, block-aggregated sequence, per-subcarrier set, per-user set, per-beam set, per-stream set, per-codeword set, or per-link set. The recognition coefficient may therefore be computed for a single controlled quantity or for a plurality of controlled quantities at different granularities within the same wireless system. In some embodiments, the recognition coefficient is applied elementwise to a vector or matrix of values. In some embodiments, the recognition coefficient is derived from a shared metric and reused across multiple controlled parameters. In some embodiments, separate recognition coefficients are computed for different resources, users, beams, streams, codewords, or links.

In preferred embodiments, the positive constant used in the bounded monotone mapping is X_opt=phi/pi. In broader embodiments, the positive constant may be a stored design constant, a configured constant, a calibrated constant, or another positive constant suitable for the intended control law. Likewise, some embodiments use a direct-map control law in which the controlled quantity increases as a quality-related metric improves, while other embodiments use an inverse-map control law in which the controlled quantity increases as uncertainty, impairment, interference, or error risk increases, or decreases as the quality-related metric improves. In still further embodiments, both direct-map and inverse-map control laws are available within the same apparatus or system and are selected according to the function being controlled.

Although X_opt=phi/pi is a preferred constant and may be associated with the preferred cost-function provenance described herein, the disclosed wireless control architecture is not limited to implementations that depend on acceptance of that provenance. In broader embodiments, the bounded monotone recognition mapping is used operationally as a wireless control law with any suitable positive constant, including a stored design constant, calibrated constant, configured constant, or provisioned constant, provided that the resulting mapping remains suitable for the intended wireless adaptation function.

The recognition metric may be obtained from any suitable measured, estimated, inferred, filtered, averaged, or predicted wireless quantity already described herein, including signal quality, error-related behavior, channel-related behavior, beam-related behavior, decoding-related behavior, scheduling-related behavior, queue-related behavior, interference-related behavior, or load-related behavior. In some implementations, a metric initially represented in logarithmic units is converted into linear form before recognition mapping. In some implementations, a metric is normalized using stored scaling parameters, bias values, clipping values, offset values, reference values, or conversion factors. In some implementations, the metric is filtered or averaged over time before application of the bounded monotone mapping so that rapid fluctuations do not cause undesirable control jitter.

The recognition coefficient may be applied at any suitable scope within a wireless platform. By way of example, the coefficient may be applied per subcarrier, per tone group, per resource block, per pilot group, per antenna element, per subarray, per beam, per spatial stream, per user, per codeword, per packet, per link, or across a wider cross-layer scheduling domain. In some embodiments, one subsystem uses a locally computed recognition coefficient independently of other subsystems. In other embodiments, a shared recognition coefficient or shared positive constant is reused across two or more subsystems so that transmitter-side control, receiver-side control, beamforming control, coding control, and scheduling control operate within a common recognition framework. Such reuse can reduce threshold proliferation and can improve consistency across interacting wireless functions.

Update timing may likewise vary according to implementation needs. In some embodiments, recognition-based control is updated on a sample basis, symbol basis, slot basis, packet basis, codeword basis, beam-update basis, frame basis, or event-triggered basis. In some embodiments, the recognition coefficient is averaged, smoothed, windowed, or otherwise aggregated over multiple updates before being applied to a controlled parameter. For example, an implementation may average recognition coefficients over 8 symbols, 8 slots, 8 pilot groups, or 8 beam sweeps, or may use an 8-state control sequence, to reduce control jitter, reduce aliasing, or improve update stability. Such windowed or phased embodiments are optional and need not be used in all implementations.

The disclosed subject matter may be realized in hardware, firmware, software, or combinations thereof. In various implementations, the recognition mapping engine and related control functions are implemented using ASIC logic, FPGA logic, DSP logic, GPU-assisted processing, CPU-executed modem software, software-defined radio firmware, or mixed hardware-software partitions. The implementation may employ fixed-point arithmetic, floating-point arithmetic, lookup tables, reciprocal approximations, pipelined arithmetic stages, vectorized arithmetic stages, dedicated registers, shared memory, ROM-resident constants, DMA-supported transfers, interrupt-driven updates, scheduled control tasks, application programming interfaces, or virtualized network-control interfaces. The disclosed techniques may be executed locally at a wireless node, centrally at a controller, or in distributed form across multiple cooperating entities.

In some embodiments, provisioning and interoperability features are included so that the disclosed recognition-based control framework can coexist with legacy or standards-defined wireless behavior. For example, the positive constant, normalization parameters, and conversion parameters may be stored in ROM, nonvolatile memory, configuration memory, or remotely provisioned control memory. Measurement chains may be calibrated during manufacturing, commissioning, or field maintenance. A standards-compliant fallback mode may be provided so that operation can revert to legacy tables, legacy thresholds, or legacy adaptation logic when recognition-based control is disabled, unavailable, or not permitted for a given operating context. Telemetry or logging may be used to record recognition metrics, recognition coefficients, selected control modes, fallback events, and resulting performance indicators for validation, debugging, compliance review, or later tuning. Remote firmware or software updates may be used to modify implementation details without changing the underlying recognition-mapping framework.

The embodiments described herein are illustrative rather than limiting. Features described in connection with one embodiment may be combined with features described in connection with another embodiment so long as such combination is technically compatible and not inconsistent with the present disclosure. Accordingly, the present disclosure is intended to cover transmit-only embodiments, receive-only embodiments, cross-layer embodiments, node-local embodiments, centralized embodiments, distributed embodiments, apparatus embodiments, method embodiments, and non-transitory computer-readable-medium embodiments that employ the bounded monotone recognition mapping framework described herein. No feature, step, or implementation detail described in this detailed description should be understood as required unless expressly recited in a claim.

What is claimed is:

1. A wireless communication system, comprising:
a wireless interface configured to transmit or receive at least one wireless signal; and
processing circuitry configured to:
obtain at least one non-negative recognition metric associated with a wireless condition;
compute from the at least one non-negative recognition metric a bounded monotone recognition coefficient according to F_cov(r)=r/(r+X), where r denotes the at least one non-negative recognition metric and X denotes a positive constant; and
control at least one wireless operating parameter associated with transmission, reception, channel estimation, equalization, synchronization, coding, retransmission, power control, beamforming, precoding, combining, scheduling, handover, multi-link selection, routing, interference management, or cross-layer resource allocation using the bounded monotone recognition coefficient or a complement of the bounded monotone recognition coefficient.

2. The wireless communication system of claim 1, wherein X=phi/pi, where phi=(1+sqrt(5))/2.

3. The wireless communication system of claim 1, wherein the processing circuitry is configured to use the bounded monotone recognition coefficient as a direct-map control variable when the at least one wireless operating parameter is intended to increase as a quality-related recognition metric improves.

4. The wireless communication system of claim 1, wherein the processing circuitry is configured to compute the complement as F_comp(r)=1−F_cov(r)=X/(r+X) and to use the complement when the at least one wireless operating parameter is intended to increase as uncertainty, impairment, interference, or error risk increases or to decrease as the quality-related recognition metric improves.

5. The wireless communication system of claim 1, wherein the processing circuitry is configured to control a first wireless operating parameter in a first wireless subsystem and a second wireless operating parameter in a second wireless subsystem using a same positive constant X or a same recognition metric family.

6. The wireless communication system of claim 1, wherein the at least one wireless operating parameter comprises a transmitter-side parameter selected from transmission power, modulation order, constellation shaping, coding selection, pilot boosting, waveform selection, resource selection, precoding, and beam selection.

7. The wireless communication system of claim 6, wherein the transmitter-side parameter comprises transmission power controlled on a total-link, per-subcarrier, per-resource-block, per-layer, per-beam, or per-user basis using the bounded monotone recognition coefficient, the complement, or both.

8. The wireless communication system of claim 1, wherein the at least one wireless operating parameter comprises a receiver-side parameter selected from channel estimation, equalization, synchronization, soft demapping, decoder confidence weighting, carrier-frequency-offset correction, timing-offset correction, phase-noise tracking, Doppler adaptation, and pilot-density adaptation.

9. The wireless communication system of claim 8, wherein the processing circuitry is configured to compute a weighted channel estimate from an initial channel estimate H0 according to H_hat=H0.*F_cov(|H0|\hat{ }2) or H_hat=H0*F_comp(U_H), where U_H denotes an uncertainty or noise metric and .* denotes elementwise multiplication.

10. The wireless communication system of claim 1, wherein the at least one wireless operating parameter comprises an array-side or network-side parameter selected from element spacing, element weighting, beam search, beam refinement, beam tracking, beam handoff, sidelobe control, null steering, interference suppression, resource assignment, user ranking, handover, dual-connectivity selection, multi-link selection, routing, and cross-layer scheduling, and wherein the processing circuitry is configured to compute a composite score from multiple recognition metrics using a product aggregation, a minimum aggregation, an average aggregation, or a complement-product aggregation.

11. A wireless communication method, comprising:
obtaining at least one non-negative recognition metric associated with a wireless condition;
computing from the at least one non-negative recognition metric a bounded monotone recognition coefficient according to F_cov(r)=r/(r+X), where X is a positive constant;
selecting either the bounded monotone recognition coefficient or a complement of the bounded monotone recognition coefficient for a control law associated with at least one wireless operating parameter; and
adjusting the at least one wireless operating parameter for transmission, reception, channel estimation, equalization, synchronization, coding, retransmission, power control, beamforming, precoding, combining, scheduling, handover, multi-link selection, routing, interference management, or cross-layer resource allocation using the selected control law.

12. The wireless communication method according to claim 11, wherein selecting either the bounded monotone recognition coefficient or the complement comprises using the bounded monotone recognition coefficient when the at least one wireless operating parameter is intended to increase as a quality-related recognition metric improves and using the complement when the at least one wireless operating parameter is intended to increase as uncertainty, impairment, interference, or error risk increases or to decrease as the quality-related recognition metric improves.

13. The wireless communication method according to claim 11, further comprising deriving the at least one non-negative recognition metric by converting a signal-to-interference-plus-noise ratio expressed in dB to a linear metric r_sinr=10\hat{ }(SINR_dB/10), and optionally deriving a second non-negative recognition metric from a block error rate estimate BLER_est over a sliding window of W code blocks as r_bler=1/max(BLER_est, ε), where ε is a positive floor value.

14. The wireless communication method according to claim 11, wherein adjusting the at least one wireless operating parameter comprises computing respective recognition coefficients on a per-subcarrier, per-resource-block, per-layer, per-beam, per-user, per-codeword, or per-link basis, including elementwise application to a vector or matrix of values.

15. The wireless communication method according to claim 11, further comprising receiving feedback from a receiver-side measurement process including a block error rate estimate BLER_est over a sliding window of W code blocks, and updating the at least one wireless operating parameter once per T slots according to a decision rule that compares BLER_est to a target BLER_target.

16. The wireless communication method according to claim 11, further comprising smoothing, averaging, or windowing the bounded monotone recognition coefficient over a window of W updates, including an 8-symbol, 8-slot, 8-pilot-group, or 8-beam-sweep window.

17. The wireless communication method according to claim 11, wherein adjusting the at least one wireless operating parameter further comprises limiting the adjustment according to at least one constraint selected from PA linearity, ACLR or spectral-mask compliance, SAR, thermal limits, battery limits, duty-cycle limits, and regulatory maximum power limits.

18. A non-transitory computer-readable medium storing instructions that, when executed by one or more processors of a wireless device or wireless infrastructure node, cause the one or more processors to:
obtain at least one non-negative recognition metric associated with a wireless condition;
compute from the at least one non-negative recognition metric a bounded monotone recognition coefficient according to F_cov(r)=r/(r+X), where X is a positive constant; and
control at least one wireless operating parameter using the bounded monotone recognition coefficient or a complement of the bounded monotone recognition coefficient.

19. The non-transitory computer-readable medium of claim 18, wherein the instructions cause the one or more processors to use X=phi/pi, where phi=(1+sqrt(5))/2, as the positive constant.

20. The non-transitory computer-readable medium of claim 18, wherein the instructions cause the one or more processors to apply the positive constant or the bounded monotone recognition coefficient across at least two wireless subsystems selected from transmitter control, receiver control, beamforming control, coding control, retransmission control, and scheduling control.
